(19) United States
(12) Patent Application Publication
(10) Pub. No.: US 2011/0214521 A1
(43) Pub. Date: Sep. 8, 2011

(54) TRANSMISSION FOR VEHICLES

(75) Inventors: Markus ROCKENBACH, Schweppenhausen (DE); Josef HAU, Ruesselsheim (DE)

(73) Assignee: GM GLOBAL TECHNOLOGY OPERATIONS LLC, Detroit, MI (US)

(21) Appl. No.: 13/041,640

(22) Filed: Mar. 7, 2011

(30) Foreign Application Priority Data
Mar. 5, 2010 (GB) 1003672.1

(51) Int. Cl. F16H 3/093

(52) U.S. Cl. 74/331

(57) ABSTRACT

A transmission for a car has a first gearwheel group that includes, but is not limited to s a fixed gearwheel first gear on an input shaft and that is meshing with an idler first gear on a first layshaft. The transmission further includes, but is not limited to an idler reverse gear on a second layshaft, the idler reverse gear meshing with the idler first gear on the first layshaft, wherein gearwheels of a second gearwheel group, of a third gearwheel group, and of a fourth gearwheel group being arranged on the input shaft and on the first layshaft.

### CROSS-REFERENCE TO RELATED APPLICATION

This application claims priority to British Patent Application No. 1003672.1, filed Mar. 5, 2010, which is incorporated herein by reference in its entirety.

### TECHNICAL FIELD

The technical field relates to a transmission for vehicles.

### BACKGROUND

A transmission often comprises one input shaft that is connected to and actuated by a clutch assembly, which is driven by an electric or combustion engine. FR 2,770,599 and the EP 1,270,996 show gearboxes with two layshafts of which only one layshaft carries a pinion for an output gearwheel. The gearbox of the FR 2,770,599 is complicated either because separate fixed wheels on the input shaft and on the output shaft are provided for transmitting torque in the reverse gear mode. The gearbox of the EP 1,270,996 provides a first fixed wheel reverse gear that meshes with a second idler wheel reverse gear which in turn can be connected with a first idler wheel reverse gear, the first and second idler wheels reverse gear being arranged on the same axis with a second fixed wheel reverse gear, that meshes with a fixed wheel first gear on an input shaft. For the reverse gear mode, one needs to actuate a coupling device that connects the second fixed wheel reverse gear with the first idler wheel reverse gear. This arrangement is a very complicated arrangement.

The U.S. Pat. No. 2,227,742 instead provides an operable idler wheel reverse gear for engaging the operable fixed wheel first gear in the reverse gear mode. GB 2,207,717 A and DE 198 17 318 A1 use a combination of a sliding idler gear wheel reverse gear and a toothed sleeve of a synchronizer device for providing the torque flow in the reverse gear mode. None of these designs is using an operable idler gearwheel reverse gear that meshes with the idler wheel first gear.

In view of the foregoing, at least one object is that both layshafts need to comprise a pinion for outputting a driving torque, e.g., to a differential assembly because this obviously provides a much simpler design as compared with the prior art. It is a further object to provide a simplified reverse gearwheel group that always meshes with an idler gearwheel on the first layshaft, which in turn is meshing with a fixed gearwheel on the input shaft, thereby using the idler gearwheel of the first layshaft for reversing the sense of rotation of the torque flow before outputting the torque flow over the pinion of the reverse gearwheel group. Such shifting operations are complicated and it is therefore desirable to avoid that. In addition, other objects, desirable features and characteristics will become apparent from the subsequent summary and detailed description, and the appended claims, taken in conjunction with the accompanying drawings and this background.

### SUMMARY

The idler gearwheel reverse gear is meshing with the idler gearwheel first gear on the first layshaft. A 6-speed gearbox is provided with high efficiency, low cost and low mass. The 6-speed gearbox is also compact with reduced transmission package size. The 6-speed gearbox can further be modified to provide a 5-speed gearbox by removing its sixth gearwheel group. A manual transmission powerflow is provided with six forward gears and one reverse gear for Front Wheel Drive applications.

Idler gearwheels of a first gear and of a second gear in the gearboxes can be arranged on an output shaft, which reduces rattle sensitivity of the gearboxes and improve efficiency of the gearboxes. The idler gearwheels of a first gear and of a second gear can engage the output shaft via a synchronizer. Synchronizer for a reverse gear can be located on an additional half shaft, which allows shortening the overall transmission length. Gearwheels of the gearboxes can be arranged on two shafts only, which are an input shaft and an output. The two-shaft arrangement provides improves efficiency of the gearboxes.

The 6th gear is located at the rear end of the transmission, which enables a simple low cost 5-speed option for low cost markets. The 5-speed option has two gearwheels less compared to the 6-speed version. A single-sided synchronizer must replace the double-sided synchronizer of the 6-speed version. The 6th gear arrangement allows in addition to have an optimized transmission package on the lower rear end based on the small diameter of the driven 6th gear. This is beneficial for transmission package in regard to cradle clearance.

A transmission comprises a first layshaft and a second layshaft that are radially spaced apart from the input shafts. The first layshaft and the second layshaft are essentially parallel to the input shaft. Gearwheels of the transmission are arranged on the first layshaft, on the second layshaft and on the input shaft. The gearwheels comprise a first gearwheel group, a second gearwheel group, a third gearwheel group, and a fourth gearwheel group, and a reverse gearwheel group. In addition, a fifth gearwheel group and a sixth gearwheel group can be provided for providing five or six sequentially increasing forward gears.

For example, in a vehicle having the transmission, a first gear has a gear ratio of 3:1, a second gear has a gear ratio of 1.5:1, a third gear has a gear ratio of 1.1:1, and a fourth gear has a gear ratio of 0.8:1. In another example, in a vehicle having the transmission, a first gear has a gear ratio of 3:1, a second gear has a gear ratio of 1.5:1, a third gear has a gear ratio of 1.1:1, a fourth gear has a gear ratio of 0.8:1, and a fifth gear has a gear ratio of 0.75:1. In still another example a vehicle having the transmission, a first gear has a gear ratio of 3:1, a second gear has a gear ratio of 1.8:1, a third gear has a gear ratio of 1.2:1, a fourth gear has a gear ratio of 1:1, a fifth gear has a gear ratio of 0.9:1, and a sixth gear has a gear ratio of 0.75:1.

The first gearwheel group always comprises a first fixed gearwheel on the input shaft, the first fixed gearwheel meshing with a first gear idler gearwheel on a first layshaft. The second gearwheel group comprises a second gearwheel on the input shaft that can either be a second fixed gearwheel or a second gear idler gearwheel meshing with a second gear idler gearwheel or with a second fixed gearwheel on the first layshaft. The third gearwheel group comprises a third gearwheel on the input shaft, that can either be a third fixed gearwheel or a third gear idler gearwheel, meshing with a third gear idler gearwheel or with a third fixed gearwheel on the first layshaft. The fourth gearwheel group comprises a fourth gearwheel on the input shaft, that can either be a fourth fixed gearwheel or a fourth gear idler gearwheel, meshing with a fourth gear idler gearwheel or with a fourth fixed gearwheel on the first layshaft.

The transmission provides a space saving and efficient solution for power trains with four, five, or six forward gears. A double-meshing feature is provided by the first and reverse gearwheels group. This double-meshing feature makes the transmission to be compact and lightweight at low cost because an extra fixed gearwheel on the input shaft and an extra idler shaft for the reverse gear are avoided. All gearwheels for the forward gears are mounted on the same layshaft and the two gearwheels for the reverse gear are mounted on the other layshaft. This makes the overall design neat and easy to understand.

It turned out to be advantageous to provide the gearwheels for the first gear and for the reverse gear next to the pinions of the layshaft. According to the application, bearings are provided for supporting the layshafts. These bearings are provided in the area between the pinions and the gearwheels of the first gear respectively the gearwheels of the reverse gear. The supported shaft can be made slim and have less deflection when the bearings are next to those gearwheels, which produce the biggest torques. The pinions transmit torques for driving the vehicle.

It is further advantageous that the arrangement of the forward gears on their input shaft and the first layshaft is such that they are sequentially increasing or decreasing, with the highest gears opposite from the clutch. This means that the gearbox is easy to produce because of its modular design. If a five-speed gearbox is needed, it is only necessary to add on a further gearwheel pair to a four-speed gearbox and so on for six, seven, four, or only three speeds.

A gearbox is provided that comprises an output gearwheel. The output gearwheel meshes with the two pinions on the layshafts respectively for providing an output torque. The output gearwheel receives driving torques from the two pinions and offers a single output to the exterior of the transmission. No multiple external connections that are associated to the layshafts are required. Connection to the transmission is thus made simple.

The present application can provide a power train device with the gearbox. The power train device can comprise a power source for generating a driving torque. The power source can comprise a combustion engine or an electric motor. The application further provides a vehicle with the power train device. The vehicle having the combustion engine and the transmission is easy to manufacture. The combustion engine can consume less petrol for environment protection. Furthermore, a combustion engine for other types of fuel can have even less polluting emission, such as hydrogen fuel. Electric motor used in as hybrid car, or in an electrical car enables reduction of pollution, as compared to typical combustion using petrol. The electric motor can even recuperate brake energy in a generator mode. The vehicle having the power train device is efficient in energy usage by using the double-clutch transmission.

### BRIEF DESCRIPTION OF THE DRAWINGS

The present invention will hereinafter be described in conjunction with the following drawing figures, wherein like numerals denote like elements, and:

FIG. 1 illustrates a front view of a first embodiment of a transmission of the application with six forward gears and one reverse gear;

FIG. 2 illustrates a schematic cross-section through the transmission of FIG. 1;

FIG. 3 illustrates a front view of a second embodiment of a transmission of the application with five forward gears and one reverse gear;

FIG. 4 illustrates a schematic cross-section through the transmission of FIG. 3;

FIG. 5 illustrates an assembly of a double-sided coupling device with its neighbouring gearwheels for engagement;

FIG. 6 illustrates an assembly of a single-sided coupling device with its neighbouring gearwheel for engagement;

FIG. 7 illustrates an assembly of an idler gearwheel that is rotatably supported by a shaft on a bearing; and

FIG. 8 illustrates an assembly of a fixed gearwheel that is supported on a shaft.

### DETAILED DESCRIPTION

The following detailed description is merely exemplary in nature and is not intended to limit application and uses. Furthermore, there is no intention to be bound by any theory presented in the preceding background or summary or the following detailed description.

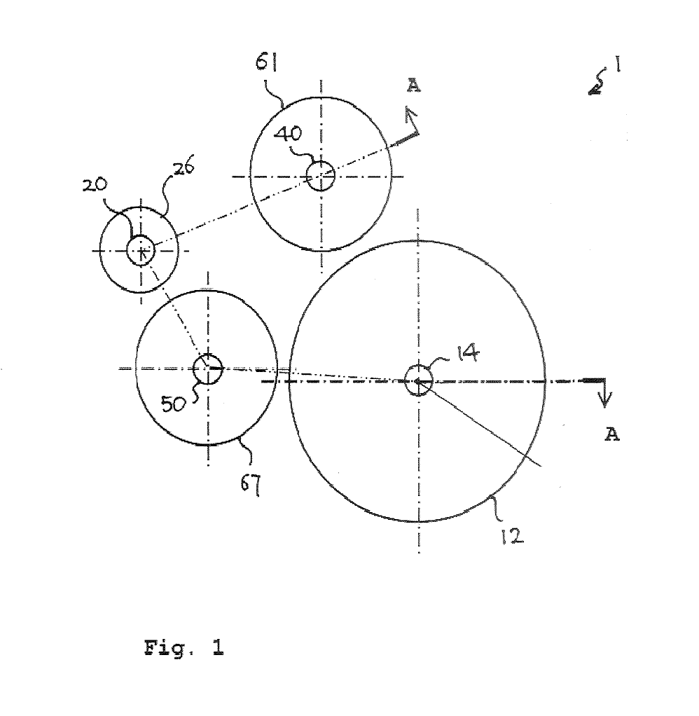

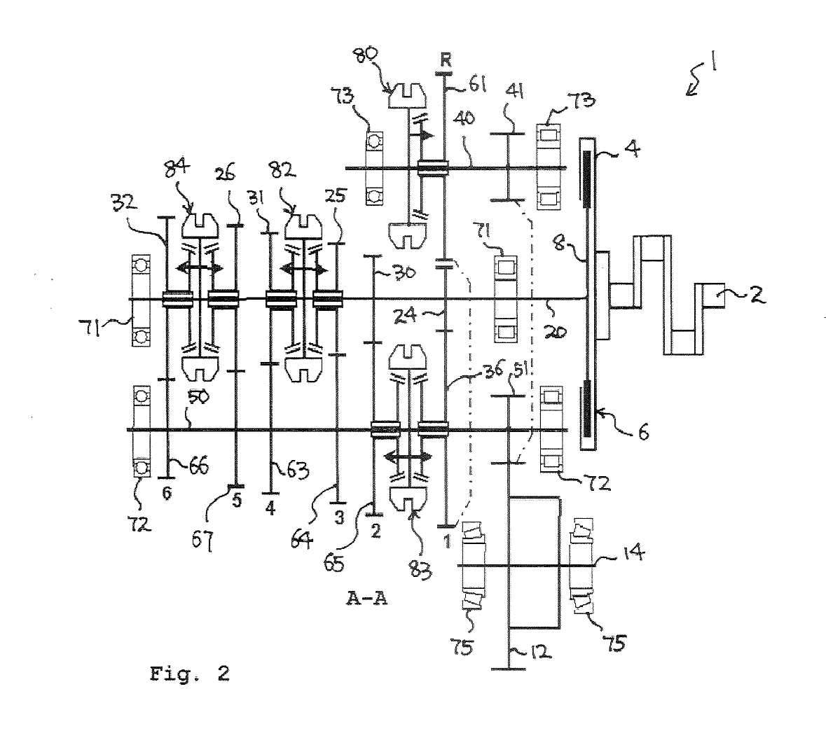

FIG. 1 and FIG. 2 provide detailed description of a first embodiment of a transmission 1 of the application. The transmission 1 comprises a relatively large output gearwheel 12 on an output shaft 14, one input shaft 20, and two pinions 41, 51 on two layshafts 40, 50. The input shaft 20 is non-rotatably connected to a clutch disc 8 of a clutch 6. The two pinions 41, 51 are an upper pinion 41 or reverse pinion 41 and a lower pinion 51 or layshaft pinion 51. The upper pinion 41 is fixed to an upper layshaft 40 or reverse gear layshaft 40 and the lower pinion is fixed to a lower layshaft 50 or layshaft 50 at their rotational axes respectively. The output gearwheel 12 is fixed to an output shaft 14 at its rotation axis. The two pinions 41, 51 mesh with the output gearwheel 12 separately at different positions of the output gearwheel 12.

The input shaft 20, the upper layshaft 40, and the lower layshaft 50 are parallel to each other at predetermined distances. The distances are provided in radial directions of these shafts, which are better seen in FIG. 2. Other wheels are mounted on these shafts respectively coupling with each other according to predetermined manners.

FIG. 2 illustrates the expanded view of the transmission 1 that shows the manners of the gearwheels mounting, which corresponds to FIG. 1. The transmission 1 comprises, from top to bottom, the upper layshaft 40, the input shaft 20, and the lower layshaft 50. The input shaft 20 is arranged inside a gearbox casing that is not shown here. The input shaft 20 is supported in the gearbox casing by a pair of input shaft bearings 71.

There are six gearwheels and two coupling devices provided on the input shaft 20. These gearwheels are, from right to left, a fixed wheel first gear 24, a fixed wheel second gear 30, an idler wheel third gear 25 which is also called idler third gear 25, a double-sided coupling device 82, an idler wheel fourth gear 31 which is also called idler fourth gear 31, an idler wheel fifth gear 26 which is also called an idler fifth gear 26, a double-sided coupling device 84, and an idler wheel sixth gear 32 which is also called idler sixth gear 32. An input shaft bearing 71 is positioned at a right side of the fixed wheel first gear 24, whilst another input shaft bearing is located on a left side of the idler sixth gear 32. A right end of the input shaft 20 is joined to a clutch disc 8 of a clutch assembly 6. A clutch housing 4 of the clutch assembly 6 is fixed onto a crakshaft 2. The input shaft 20 is configured to connect to or disconnect from the crakshaft 2 by coupling or decoupling of the clutch housing 4 and the clutch disc 8.

The layshaft 50 is provided below the input shaft 20. There are a number of gearwheels and coupling devices mounted on the layshaft 50, which include, from right to the left, the layshaft pinion 51, an idler first gear 36 which is also called an idler wheel first gear 36, a double-sided coupling device 83, an idler second gear 65 which is also called an idler wheel second gear 65, a fixed wheel third gear 64, a fixed wheel fourth gear 63, a fixed wheel fifth gear 67 and a fixed wheel sixth gear 66.

The idler first gear 36 meshes with the fixed wheel first gear 24. The idler second gear 65 meshes with the fixed wheel second gear 30. The idler third gear 25 meshes with the fixed wheel third gear 64. The fixed wheel fourth gear 63 meshes with the idler fourth gear 31. The fixed wheel fifth gear 67 meshes with the idler fifth gear 26. The fixed wheel sixth gear 66 meshes with the idler sixth gear 32.

The reverse gear layshaft 40 is provided above the input shaft 20. There are provided gearwheels and a coupling device on the reverse gear layshaft 40, which includes, from right to the left, the reverse pinion 41, an idler reverse gear 61 that is also called an idler wheel reverse gear 61, and a single-sided coupling device 80. One reverse shaft bearing 73 that is also called lay shaft bearing 73 is positioned next to the reverse pinion 41. Another reverse shaft bearing 73 that is also called lay shaft bearing 73 is positioned at the left end of the upper layshaft 40, next to the single-sided coupling device 80. The idler reverse gear 61 is mounted on the upper layshaft 40 by needle bearings such that the idler reverse gear 61 is free to rotate around the reverse gear layshaft 40. The idler reverse gear 61 meshes with the idler first gear 36. The single-sided coupling device 80 is configured to move along the upper layshaft 40 to engage or disengage the idler reverse gear 61 to the upper layshaft 40. The transmission 1 comprises a double-meshing feature that the idler first gear 36 meshes with both the idler reverse gear 61 and the fixed wheel first gear 24.

In the present application, the expressions “mesh” and “comb” with respect to geared wheels, coupled sprockets or engaged gearwheels are provided as synonyms. Wheel, idler, pinion and sprocket can also be termed as gearwheel, unless otherwise specified. The output gearwheel 12 is part of a differential gear that is not described here. The differential gear is represented by a box symbol at the output gearwheel 12. The clutch assembly 6 is also known as a clutch. The term “coupling device” is alternatively termed as “shifting mechanism” or “synchronizer” for engaging or disengaging gearwheels on a shaft. Any one of the input shaft 20 and layshafts 40, 50, can be supported by more than two bearings. Bearings that support gearwheels on shafts include needle-roller bearings. Bearings that hold shafts on the gearbox casing include ball bearings 71, 72, 73 and tapered roller bearings 75.

In figures, dash lines indicate combing relationship between the gearwheels.

The transmission 1 according to the application can be used as a manual transmission. In the manual transmission, a drive shaft for the front axle of a vehicle extends outward from its transmission case, and parallel to the output shaft 14 of the transmission 1. The arrangement of the manual transmission provides sufficient space for actuation of the manual transmission and clutch and for an electric motor. The electric motor can act as a starter device for a combustion engine, as an energy recuperation device for brake operation or as an additional drive means in hybrid vehicles.

The application provides a compact structure of a parallel transmission. The transmission 1 is particularly well suited for transverse installation in front-wheel drive vehicles in which the front differential, for example, is positioned below the pinions 41, 51. A small overall volume of the power train for transmitting torques can be achieved.

The application provides at least two relatively small pinions 41, 51 on intermediately arranged layshafts 40, 50 that comb with one relatively big output gearwheel 12. The output gearwheel 12 in turn is fixed onto the output shaft 14. This arrangement provides a compact and lightweight transmission 1. The application further allows a design in which the output gearwheel 12 is integrated into a transmission differential device without providing an intermediate output shaft of the transmission 1. This allows a very dense packaging situation for the transmission 1.

It is further advantageous to provide the fixed wheels for the first and the second gears on the input shaft 20, in addition to having the fixed gearwheels of the third gear 64, the fourth gear 63, the fifth gear 67 and the sixth gear 66 on the lower layshaft 50. This arrangement provides the above-mentioned power-shift operation in a smooth and efficient manner when gearshift is performed sequentially. This can also be done such that one or more of the fixed gear wheels 64, 63, 67, 66 of the third gear, the fourth gear, the fifth gear and the sixth gears are provided on the input shaft 20. For each fixed wheel of a forward gear on one shaft, there is provided an idler wheel on the other shaft.

Bearings 72, 73 of the transmission 1 are mounted on the layshafts 40, 50 next to gearwheels of low gears 41, 51. This arrangement provides stronger mechanical support to the layshafts 40, 50 for less shaft deflection. The input shaft bearings 71 are provided next o the fixed wheel first gear 24, which also transmits a large torque at low speed. This arrangement reduces the input shaft's 20 bending under the large torque. As a result, the input shaft 20 and the layshafts 40, 50 can be reduced in weight and cost. There are two pinions 41, 51 provided for six forward gears and one reverse gear. The reduced number of pinions enables reduction in size, cost and weight of the transmission 1.

In the following, the various paths of torque flow of the transmission will be described. An input torque of the first gear is received from a crakshaft 2 of a combustion engine (not shown). The input torque of the first gear is received by the input shaft 20 from the clutch 6 of the transmission 1. The torque of the first gear is transmitted from the input shaft 20 via the fixed wheel first gear 24 to the idler first gear 36, via the double-sided coupling device 83, via the layshaft 50, via the layshaft pinion 51, via the output gearwheel 12, to the output shaft 14. The number of tooth engagements or engaged gear pairs for the torque transfer of the first gear is two.

The path of torque flow of a second gear transmission ratio is as follows. An input torque of the second gear is received from the crankshaft 2 of the combustion engine (not shown). The input torque of the second gear is received by the input shaft 20 from the clutch 6 of the transmission 1. A torque of the second gear is transmitted from the input shaft 20, via the fixed wheel second gear 30, via the idler second gear 65, via the double-sided coupling device 83, via the layshaft 50, via the layshaft pinion 51, via the output gearwheel 12, to the output shaft 14. The number of tooth engagements or engaged gear pairs for the torque transfer of the second gear is two.

The path of torque flow of a third gear transmission ratio is as follows. An input torque of the third gear is received from the crankshaft 2 of the combustion engine (not shown). The input torque of the third gear is received by the input shaft 20 from the clutch 6 of the transmission 1. A torque of the third gear is transmitted from the input shaft 20, via the double-sided coupling device 82, via the idler third gear 25, via the fixed wheel third gear 64, via the layshaft 50, via the layshaft pinion 51, via the output gearwheel 12, o the output shaft 14. The double-sided coupling device 82 is engaged to the idler third gear 25 when transmitting the torque of the third gear. The number of tooth engagements or engaged gear pairs for the torque transfer of the third gear is two.

The path of torque flow of a fourth gear transmission ratio is as follows. An input torque of the fourth gear is received from the crankshaft 2 of the combustion engine (not shown). The input torque of the fourth gear is received by the input shaft 20 from the clutch 6 of the transmission 1. A torque of the fourth gear is transmitted from the input shaft 20, via the double-sided coupling device 82, via idler fourth gear 31, via the fixed wheel fourth gear 63, via the layshaft 50, via the layshaft pinion 51, via the output gearwheel 12, to the output shaft 14. The double-sided coupling device 82 is engaged to the idler fourth gear 31 when transmitting the torque of the fourth gear. The number of tooth engagements or engaged gear pairs for the torque transfer of the fourth gear is two.

The path of torque flow of a fifth gear transmission ratio is as follows. An input torque of the fifth gear is received from the crakshaft 2 of a combustion engine (not shown). According to FIG. 6, the input torque of the fifth gear is received by the input shaft 20 from the clutch 6 of the transmission 1. A torque of the fifth gear is transmitted from the input shaft 20, via the double-sided coupling device 84, via the idler fifth gear 26, via the fixed wheel fifth gear 67, via the layshaft 50, via the layshaft pinion 51, via the output gearwheel 12, to the output shaft 14. The double-sided coupling device 84 is engaged to the idler fifth gear 26 when transmitting the torque of the fifth gear. The number of tooth engagements or engaged gear pairs for the torque transfer of the fifth gear is two.

The path of torque flow of a sixth gear transmission ratio is as follows. An input torque of the sixth gear is received from the crankshaft 2 of a combustion engine (not shown). According to FIG. 6, the input torque of the sixth gear is received by the input shaft 20 from the clutch 6 of the transmission 1. A torque of the fifth gear is transmitted from the input shaft 20, via the double-sided coupling device 84, via the idler sixth gear 32, via the fixed wheel sixth gear 66, via the layshaft 50, via the layshaft pinion 51, via the output gearwheel 12, to the output shaft 14. The double-sided coupling device 84 is engaged to the idler sixth gear 32 when transmitting the torque of the sixth gear. The number of tooth engagements or engaged gear pairs for the torque transfer of the sixth gear is two.

The path of torque flow of the reverse gear transmission ratio is as follows. An input torque of the reverse gear is received from the crankshaft 2 of a combustion engine (not shown). The input torque of the reverse gear is received by the input shaft 20 from the clutch 6 of the transmission 1. A torque of the reverse gear is transmitted from the input shaft 20, via the first fixed wheel first gear 24, via the idler first gear 36, via the idler reverse gear 61, via the single-sided coupling device 80, via the reverse gear layshaft 40, via the reverse pinion 41, via the output gearwheel 12, to the output shaft 14. The single-sided coupling device 83 is detached or loosened from the idler first gear 36 while the single-sided coupling device 80 is engaged to the idler reverse gear 61 when transmitting the torque of the reverse gear. The number of tooth engagements or engaged gear pairs for the torque transfer of the first reverse gear is three.

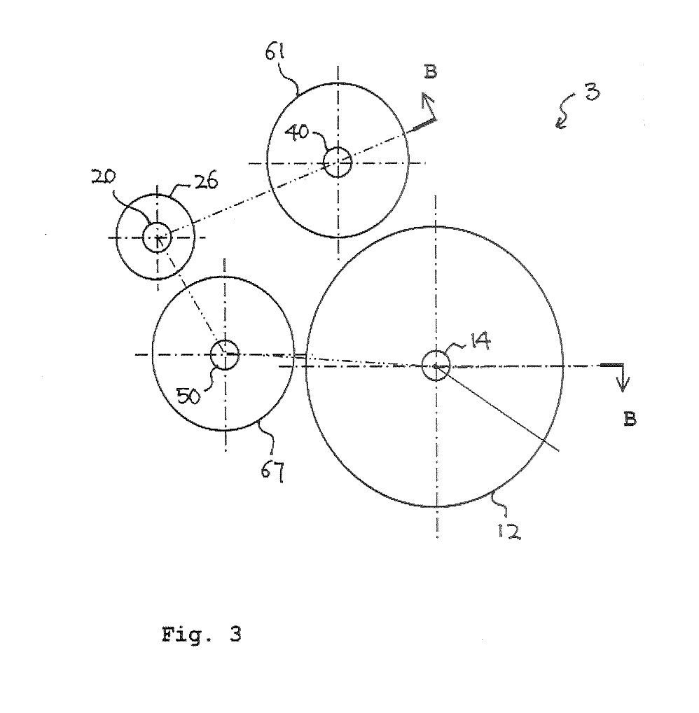

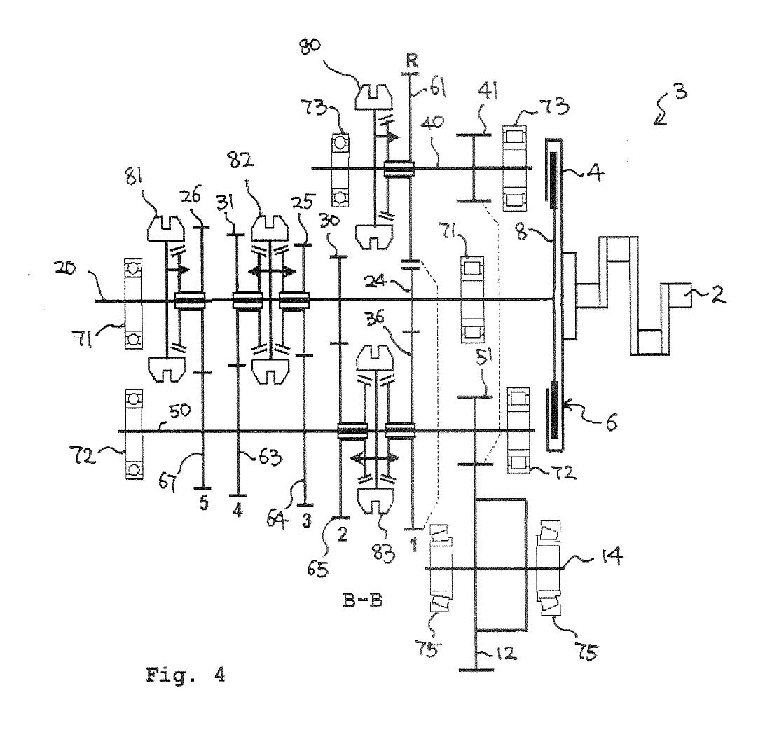

The second embodiment according to FIG. 3 and FIG. 4 has five gears. The five gears are provided by replacing the double-sided coupling device 84 by a single-sided coupling device 81 and by removing both the idler sixth gear 32 and the fixed wheel sixth gear. All the torque flows for the first five gears and the reverse gear remain essentially the same, as described above for the first embodiment, except that the single-sided coupling device 81 is used for engaging the fifth gear.

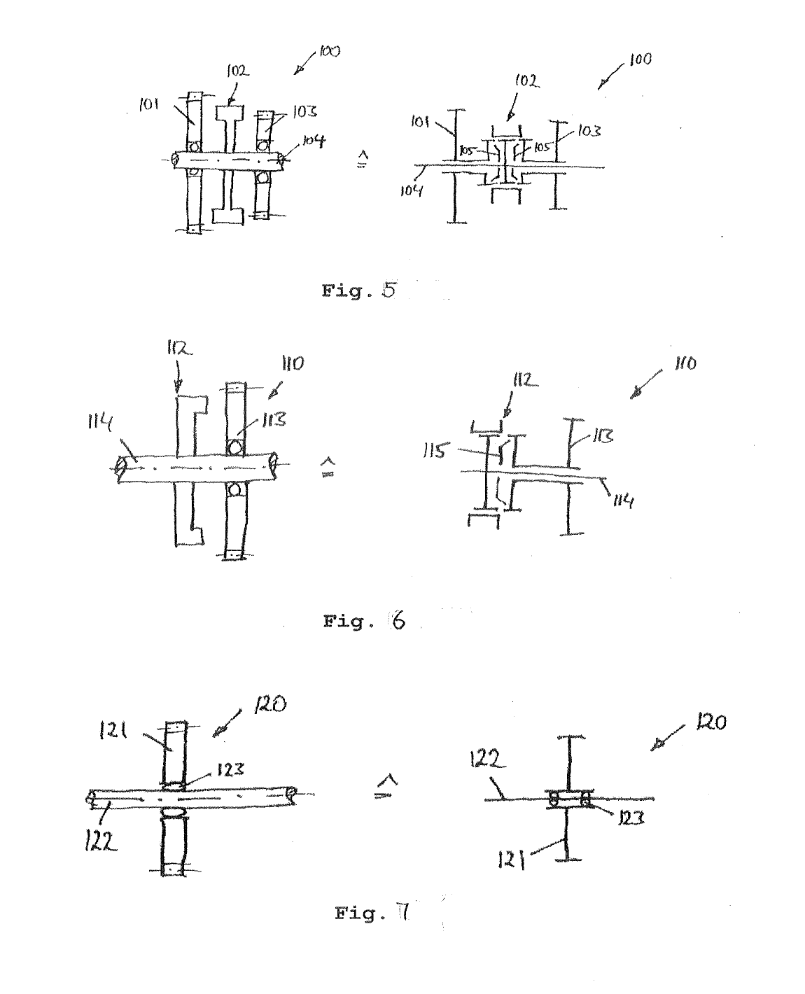

FIG. 5 illustrates an assembly 100 of a double-sided coupling device 102 with its neighbouring idlers 101, 103 for engagement. The assembly 100 comprises a shaft 104 with the two coaxially mounted idlers 101, 103 on two bearings respectively. The coupling device 102 is provided between the idler 101 on the left and the idler 103 on the right. The double-sided coupling device 102 is configured to move along the shaft 104 to selectively engage any of the idlers 101, 103 at one time. In other words, the idlers 101, 103 can alternatively be brought into non-rotating engagement with the shaft 104 by the double-sided coupling device 102. Symbols for showing the assembly 100 is provided at the right hand side of FIG. 5.

FIG. 6 illustrates an assembly 110 of a single-sided coupling device 112 with its neighbouring idler 113 for engagement. The assembly 110 comprises a shaft 114 with the one coaxially mounted idler 113 on a bearing. The single-sided coupling device 112 is provided next to the idlers 113 on the left side. The coupling device 112 is configured to move along the shaft 114 to engage or disengage the idler 113. In other words, the idler 113 can be brought into non-rotating engagement with the shaft 114 by the single-sided coupling device 112. Symbols for showing the assembly 110 are provided at the right hand side of FIG. 6.

The aforementioned coupling devices can comprise one or two synchronizing devices for either freely rotating or locking the gears to the shaft. The locking mechanism for a gear consists of a collar or “og collar” on the shaft that is able to slide sideways so that teeth or “dogs” on its inner surface bridge two circular rings with teeth on their outer circumference so that one is attached to the gear and one is attached to the shaft. When the rings are bridged by the collar, that particular gear is rotationally locked to the shaft and determines the output speed of the transmission. The gearshift lever manipulates the collars using a set of likages, so arranged so that one collar may be permitted to lock only one gear at any one time. During shifting of the gears, the locking collar from one gear is disengaged before that of another engaged. One collar often serves for two gears; sliding in one direction selects one transmission speed, in the other direction selects another.

In a synchromesh gearbox, to correctly match the speed of the gear to that of the shaft as the gear is engaged, the collar initially applies a force to a cone-shaped brass clutch attached to the gear, which brings the speeds to match prior to the collar locking into place. The collar is prevented from bridging the locking rings when the speeds are mismatched by synchro rings also called “blocker rings” or “balk rings”. The synchro rings have a sloping engagement so as long as they drag rotationally, they hold the dog clutch out of engagement. The brass clutch ring gradually causes parts to spin at the same speed. When they do spin the same speed, there is no more force on the sloping surfaces of the synchro rings, and the dog clutch is allowed to fall in to engagement.

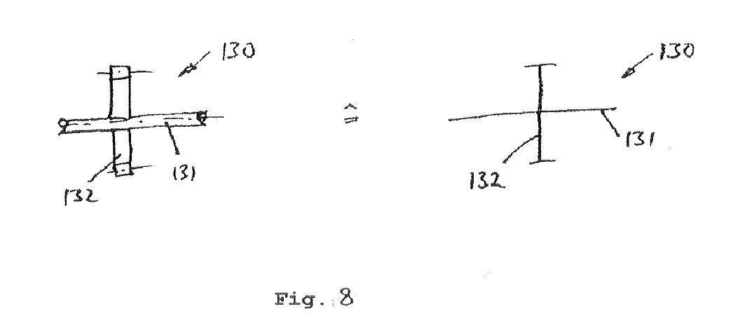

FIG. 7 illustrates an assembly 120 of an idler 121 that is rotatably supported by a shaft 122 on a bearing 123. The idler 121 is coaxially mounted onto the shaft 122 via the bearing 123. The bearing 123 enables the idler 121 to be freely rotated around the shaft 122. Symbols that represent the assembly 120 are provided at the right hand side of the FIG. 7.

FIG. 8 illustrates an assembly 130 of a fixed gearwheel 132 that is supported on a shaft 131. The fixed gearwheel 132 is coaxially mounted onto the shaft 131 such that the gearwheel 132 is fixed to the shaft 132. The fixed gearwheel 132 and the shaft 131 are joined as one single body such that torque of the fixed gearwheel 132 is transmitted to the shaft 131 directly, and vice versa.

A number of fixed gearwheels are rigidly connected to the input shaft 20 and to the other shafts 14, 40, 50. A symbol as used in the previous figures for such a fixed gearwheel is provided on the left side in FIG. 9. The more commonly used symbol for such a fixed gearwheel is provided on the right side in FIG. 9.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A transmission for a vehicle, comprising:
an input shaft actuated by a clutch assembly that is driven by an engine;
a first layshaft and a second layshaft radially spaced apart from the input shaft and essentially parallel to the input shaft;
a first pinion for the first layshaft configured to produce a driving torque;
a second pinion of the second layshaft configured to produce the driving torque;
an output shaft with an output gearwheel, the output gearwheel meshing with the first pinion and the second pinion;
gearwheels arranged on the first layshaft, the second layshaft and the input shaft, the gearwheels comprising a first gearwheel group, a second gearwheel group, a third gearwheel group, a fourth gearwheel group, and a reverse gearwheel group,
wherein each gearwheel group comprises at least one fixed wheel meshing with an idler, the idler having a coupling device for selectively connecting the idler to a respective shaft,
wherein the first gearwheel group comprises a fixed gearwheel first gear on the input shaft, the fixed gearwheel first gear meshing with an idler first gear on the first layshaft,
wherein the reverse gearwheel group comprising an idler reverse gear on the second layshaft, the idler reverse gear meshing with the idler first gear on the first layshaft (50), and
wherein the gearwheels of the second gearwheel group, of the third gearwheel group, and of the fourth gearwheel group being arranged on the input shaft and on the first layshaft.

2. The transmission according to claim 1, further comprising a fifth gearwheel group, the gearwheels of the fifth gearwheel group arranged on the input shaft and on the first layshaft.

3. The transmission according to claim 2, further comprising a sixth gearwheel group, the gearwheels of the sixth gearwheel group arranged on the input shaft and on the first layshaft.

4. The transmission according to claim 1, wherein the second gearwheel group comprises a fixed wheel second gear on the input shaft meshing with an idler wheel second gear on the first layshaft.

5. The transmission according to claim 1, wherein the third gearwheel group comprises an idler wheel third gear on the input shaft meshing with a fixed wheel third gear on the first layshaft.

6. The transmission according to claim 1, wherein the fourth gearwheel group comprises an idler wheel fourth gear on the input shaft meshing with a fixed wheel fourth gear on the first layshaft.

7. The transmission according to claim 2, wherein the fifth gearwheel group comprises an idler wheel fifth gear on the input shaft meshing with a fixed wheel fifth gear on the first layshaft.

8. The transmission according to claim 3, wherein the sixth gearwheel group comprises an idler wheel sixth gear on the input shaft meshing with a fixed wheel sixth gear on the first layshaft.

9. The transmission according to claim 1, wherein the gearwheels for a first gear and the gearwheels for a reverse gear are immediately adjacent to pinions of the layshafts.

10. The transmission according to claim 1, wherein the coupling device comprises a synchronizer device.

11. A power train assembly, comprising:
a power source configured to generate a driving torque; and
a transmission comprising:
an input shaft actuated by a clutch assembly that is driven by the power source;
a first layshaft and a second layshaft radially spaced apart from the input shaft and essentially parallel to the input shaft;
a first pinion for the first layshaft configured to produce the driving torque;
a second pinion of the second layshaft configured to produce the driving torque;
an output shaft with an output gearwheel, the output gearwheel meshing with the first pinion and the second pinion;
gearwheels arranged on the first layshaft, the second layshaft and the input shaft, the gearwheels comprising a first gearwheel group, a second gearwheel group, a third gearwheel group, a fourth gearwheel group, and a reverse gearwheel group,
wherein each gearwheel group comprises at least one fixed wheel meshing with an idler, the idler having an operable coupling device for selectively connecting the idler to a respective shaft,
wherein the first gearwheel group comprises a fixed gearwheel first gear on the input shaft, the fixed gearwheel first gear meshing with an idler first gear on the first layshaft,
wherein the reverse gearwheel group comprising an idler reverse gear on the second layshaft, the idler reverse gear meshing with the idler first gear on the first layshaft (50), and
wherein the gearwheels of the second gearwheel group, of the third gearwheel group, and of the fourth gearwheel group being arranged on the input shaft and on the first layshaft.

12. The power train assembly according to claim 11, further comprising a fifth gearwheel group, the gearwheels of the fifth gearwheel group arranged on the input shaft and on the first layshaft.

13. The power train assembly according to claim 12, further comprising a sixth gearwheel group, the gearwheels of the sixth gearwheel group arranged on the input shaft and on the first layshaft.

14. The power train assembly according to claim 11, wherein the second gearwheel group comprises a fixed wheel second gear on the input shaft meshing with an idler wheel second gear on the first layshaft.

15. The power train assembly according to claim 11, wherein the third gearwheel group comprises an idler wheel third gear on the input shaft meshing with a fixed wheel third gear on the first layshaft.

16. The power train assembly according to claim 11, wherein the fourth gearwheel group comprises an idler wheel fourth gear on the input shaft meshing with a fixed wheel fourth gear on the first layshaft.

17. The power train assembly according to claim 12, wherein the fifth gearwheel group comprises an idler wheel fifth gear on the input shaft meshing with a fixed wheel fifth gear on the first layshaft.

18. The power train assembly according to claim 11, wherein the power source is a combustion engine.

19. The power train assembly according to claim 11, wherein the power source is an electric engine.

20. The power train assembly according to claim 11, wherein the power source is connected to the input shaft.
